(19) United States
(12) Patent Application Publication
(10) Pub. No.: US 2026/0237104 A1
(43) Pub. Date: Aug. 13, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Semih ESENLIK, Los Angeles, CA (US); Yaojun WU, Beijing (CN); Zhaobin ZHANG, Los Angeles, CA (US); Meng WANG, Hong Kong (CN); Kai ZHANG, Los Angeles, CA (US); Li ZHANG, Los Angeles, CA (US)

(21) Appl. No.: 19/645,006

(22) Filed: Apr. 10, 2026

Related U.S. Application Data
(63) Continuation of application No. PCT/CN2024/123764, filed on Oct. 9, 2024.

(30) Foreign Application Priority Data
Oct. 10, 2023 (WO) PCT/CN2023/123868

(51) Int. Cl. G06T 9/00; H04N 19/13; H04N 19/70; H04N 19/91

(52) U.S. Cl. CPC G06T 9/002; H04N 19/13; H04N 19/70; H04N 19/91

(57) ABSTRACT

A solution for visual data processing is provided. A method for visual data processing is proposed. The method comprises: performing a first conversion between visual data and a bitstream of the visual data with a neural network (NN)-based model, the first conversion comprising at least one of the following: converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or converting, based on a second predetermined order, a one-dimensional second array to a second tensor having more than one dimension, the second tensor and the second array storing second data associated with the visual data.

### CROSS REFERENCE TO RELATED APPLICATIONS

This application is a continuation of International Application No. PCT/CN2024/123764, filed on Oct. 9, 2024, which claims the benefit of International Application No. PCT/CN2023/123868, filed on Oct. 10, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding quality of neural network-based image/video coding is generally expected to be further improved.

### SUMMARY

Embodiments of the present disclosure provide a solution for visual data processing.

In a first aspect, a method for visual data processing is proposed. The method comprises: performing a first conversion between visual data and a bitstream of the visual data with a neural network (NN)-based model, the first conversion comprising at least one of the following: converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or converting, based on a second predetermined order, a one-dimensional second array to a second tensor having more than one dimension, the second tensor and the second array storing second data associated with the visual data, and the second predetermined order indicating a correspondence between samples of the second tensor and samples of the second array.

Based on the method in accordance with the first aspect of the present disclosure, the conversion between a tensor having more than one dimension and a one-dimensional array is performed based on a predetermined order which indicates a correspondence between samples of the tensor and samples of the array. Compared with the conventional solution where the scan order for such conversions is not explicitly defined, the proposed method can advantageously ensure the conversion between the multi-dimensional tensor the one-dimensional array being performed according to a same scan order at different devices. Thereby, the conversion process can be performed uniformly, and discrepancy between results of performing the conversion process at different devices can be avoided. Thereby, the coding quality can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: performing a first conversion between the visual data and the bitstream with a neural network (NN)-based model, the first conversion comprising at least one of the following: converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or converting, based on a second predetermined order, a one-dimensional second array to a second tensor having more than one dimension, the second tensor and the second array storing second data associated with the visual data, and the second predetermined order indicating a correspondence between samples of the second tensor and samples of the second array.

In a fifth aspect, a method for storing a bitstream of visual data is proposed. The method comprises: performing a first conversion between the visual data and the bitstream with a neural network (NN)-based model, the first conversion comprising at least one of the following: converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or converting, based on a second predetermined order, a one-dimensional second array to a second tensor having more than one dimension, the second tensor and the second array storing second data associated with the visual data, and the second predetermined order indicating a correspondence between samples of the second tensor and samples of the second array; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example decoding process according to some embodiments of the present disclosure;

FIG. 8 illustrates an example learning-based image codec architecture;

FIG. 9 illustrates an example synthesis transform for learning based image coding;

FIG. 10 illustrates an example LeakyReLU activation function;

FIG. 11 illustrates an example ReLU activation function;

FIG. 12 illustrates an example of reshaping a one-dimensional array of cube flags into a two-dimensional array;

FIG. 13 illustrates an example structure of a neural network based decoder;

FIG. 14 illustrates an example conversion according to some embodiments of the present disclosure;

FIG. 15 illustrates a scan order according to some embodiments of the present disclosure;

FIG. 16 illustrates another scan order according to some embodiments of the present disclosure;

FIG. 17 illustrates a further scan order according to some embodiments of the present disclosure;

FIG. 18 illustrates an example embodiment according to some embodiments of the present disclosure;

FIG. 19 illustrates a flowchart of a method for visual data processing in accordance with embodiments of the present disclosure; and

FIG. 20 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment.

Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

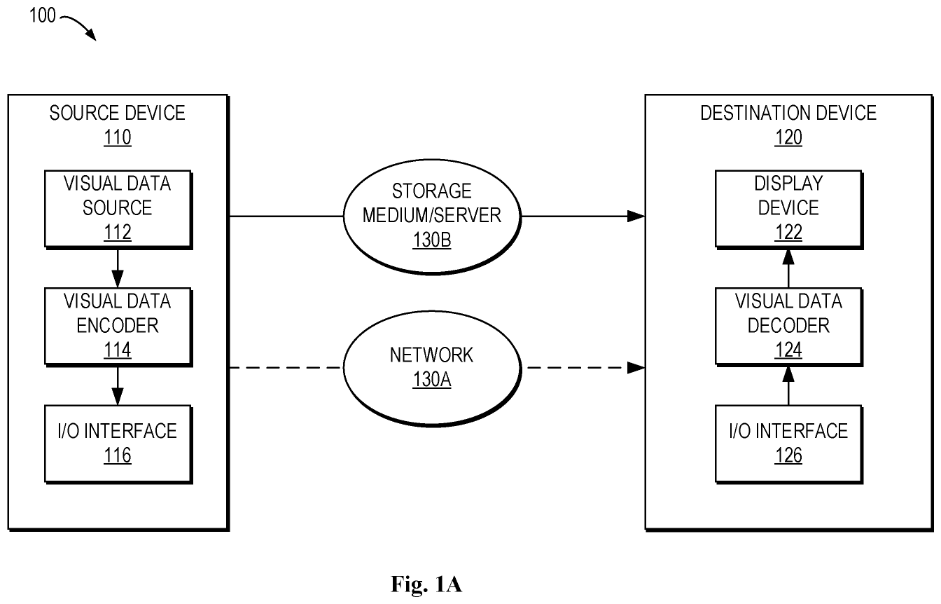

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. BRIEF SUMMARY

The present disclosure is related to neural network (NN)-based image and video coding. Specifically, it is related to conversion between tensors (which are main data units used in operation of Neural subnetworks) and arrays (which are main data units used in operation of Entropy decoding). The ideas may be applied individually or in various combinations, for image and/or video coding methods and specifications.

### 2. INTRODUCTION

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1 Image/Video Compression

Image/video compression (also referred to as image/video coding) usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory, the optimal method for lossless coding can reach the minimal coding rate −log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit −log₂ p(x) without considering the rounding error. Therefore, the remaining problem is to how to determine the probability, which is however very challenging for natural image/video due to the curse of dimensionality. Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) ... p ( {x}_{i} \vert {x}_{1} , ... , {x}_{i - 1} ) ... p ( {x}_{m \times n} \vert {x}_{1} , ... , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) ... p ( {x}_{i} \vert {x}_{i - k} , ... , {x}_{i - 1} ) ... p ( {x}_{m \times n} \vert {x}_{m \times n - k} , ... , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁.

Most of the methods directly model the probability distribution in the pixel domain. Some researchers also attempt to model the probability distribution as a conditional one upon explicit or latent representations. That being said, we may estimate

$$p ( x \vert h ) = {\prod }_{i = 1}^{m \times n} p ( {x}_{i} \vert {x}_{1} , ... , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks. FIG. 1B is an illustration of atypical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image R. The distortion is calculated in a perceptual space by transforming x and \hat{x} with the function gₚ.

It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1B, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 2.3.3 Hyper Prior Model

In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.

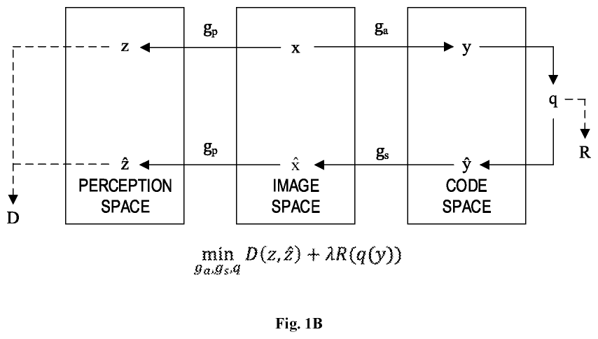

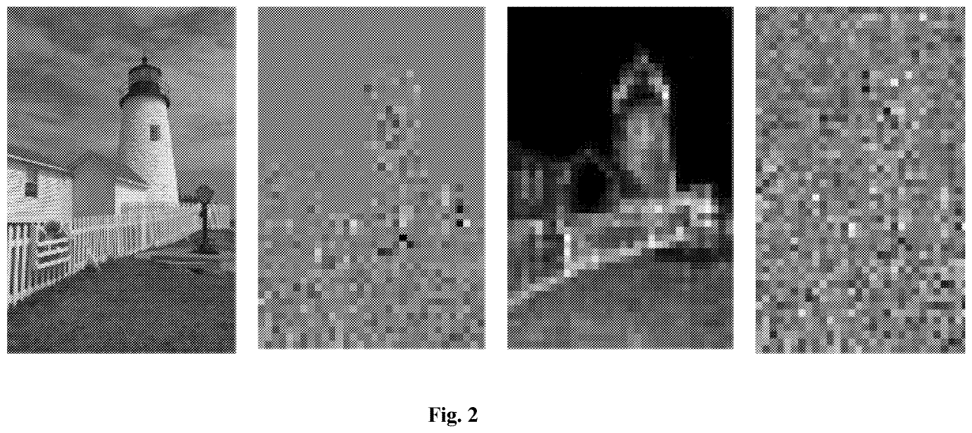

As evident from the middle left and middle right image of FIG. 2, there are significant spatial dependencies among the elements of ŷ. Notably, their scales (middle right image) appear to be coupled spatially. In an existing design, an additional set of random variables \hat{z} are introduced to capture the spatial dependencies and to further reduce the redundancies. In this case the image compression network is depicted in FIG. 3.

In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 2 correspond to the quantized latent when hyper encoder/decoder are used. Compared to middle right image, the spatial redundancies are significantly reduced, as the samples of the quantized latent are less correlated.

In FIG. 2: Left: an image from the Kodak dataset. Middle left: visualization of a the latent representation y of that image. Middle right: standard deviations σ of the latent. Right: latents y after the hyper prior (hyper encoder and decoder) network is introduced.

FIG. 3 illustrates network architecture of a autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitsteam and transmitted to the receiver (decoder) along with ŷ.

### 2.3.4 Context Model

Although the hyper prior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

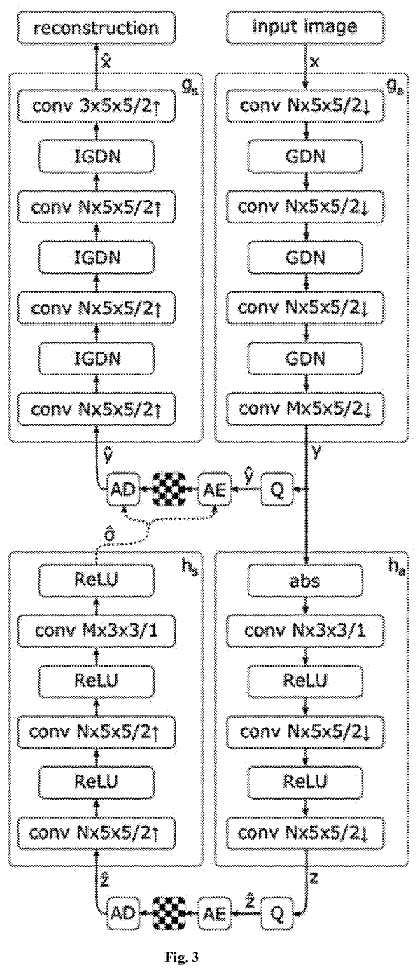

FIG. 4 is a schematic diagram illustrating an example combined model configured to jointly optimize a context model along with a hyperprior and the autoencoder. The following Table 1 illustrates meaning of different symbols.

TABLE 1
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ(y; θₕₑ) |
| Hyper-Latents | z |
| Hyper-Latents (quantized) | \hat{z} |
| Hyper Decoder | gₕ(\hat{z}; θ_{hd}) |
| Context Model | g_{cm}(y_{<i}; θ_{cm}) |
| Entropy Parameters | gₑₚ(•; θₑₚ) |
| Reconstruction | \hat{x} |

A joint architecture where both hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 4 illustrates the combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically the latent samples are modeled as gaussian distribution or gaussian mixture models (not limited to). In an existing design and according to the FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as p and a).

### 2.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, aₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as

$${y}_{s}^{′} = \hat{y} ⊙ {m}_{s}^{′}$$

where ŷ is the decoded quantized latent representation and

$${y}_{s}^{′}$$

is the inversely gained quantized latent representation, which will be fed into the synthesis network.

To achieve continuous variable rate adjustment, interpolation is used between vectors. Given two pairs of gain vectors

$$\{ {m}_{t} , {m}_{t}^{′} \} and \{ {m}_{r} , {m}_{r}^{′} \} ,$$

the interpolated gain vector can be obtained via the following equations.

$${m}_{v} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 The Encoding Process Using Joint Auto-Regressive Hyper Prior Model

The FIG. 4 corresponds to the state of the art compression method that is proposed. In this section and the next, the encoding and decoding processes will be described separately.

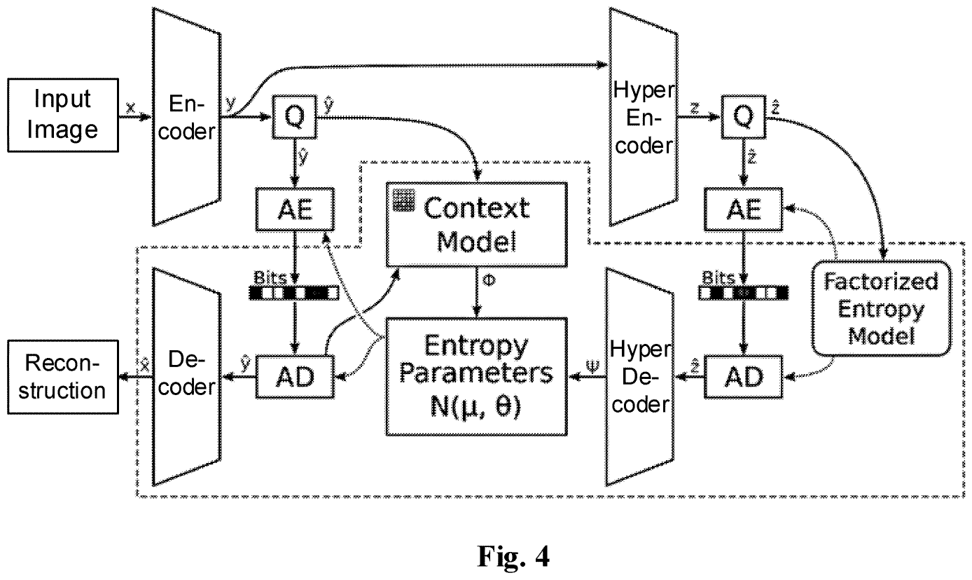

The FIG. 5 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process.

It is noted that the other names can be used for the modules described above.

In the above description, the all of the elements in FIG. 5 are collectively called encoder. The analysis transform that converts the input image into latent representation is also called an encoder (or auto-encoder).

### 2.3.7 the Decoding Process Using Joint Auto-Regressive Hyper Prior Model

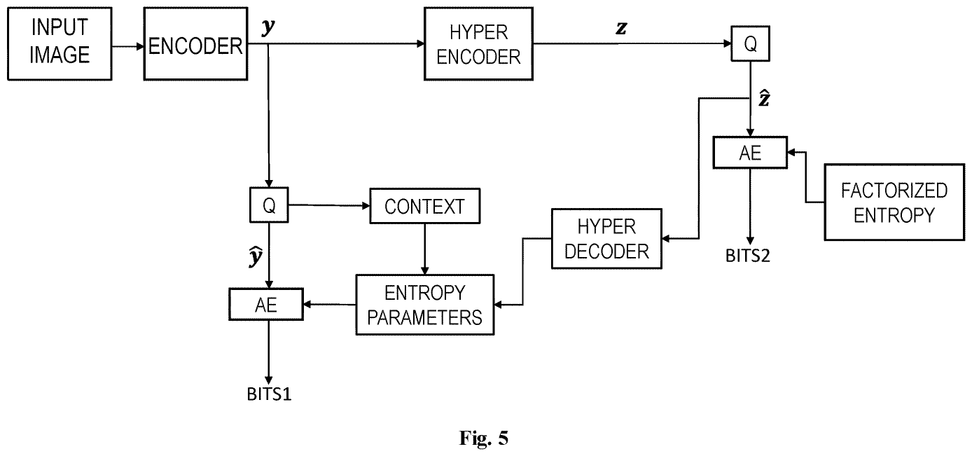

The FIG. 6 depicts the decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent 9 that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent y is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.5 Preliminaries Text Use

Almost all the natural image/video is in digital format. A grayscale digital image can be represented by x∈ [symbol] , where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] . If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 2.6 Separate Processing of Luma and Chroma Components of an Image

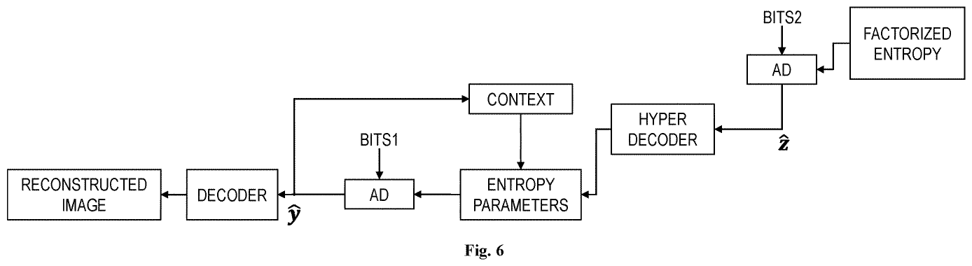

FIG. 7 illustrates the decoding process according to some embodiments of the present disclosure.

According to one implementation, the luma and chroma components of an image can be decoded using separate subnetworks. In FIG. 7, the luma component of the image is processed by the subnetwoks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of the above separate processing is that the computational complexity of the processing of an image is reduced by application of separate processing. Typically in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically the separate processing of luma and chroma components of an image does not result in a prohibitive reduction in performance, as the correlation between the luma and chroma components are typically very small.

The processing (Decoding process) in the above figure can be explained below:
1. Firstly, the factorized entropy model is used to decode the quantized latents for luma and chroma, i.e., \hat{z} and \hat{z}ᵤᵥ in FIG. 7.
2. The probability parameters (e.g. variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all of the samples of ŷ are obtained, a synthesis transform can be applied to obtain the reconstructed image.
6. For chroma component, step 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.

The module named ICCI is a neural-network based postprocessing module. The present disclosure is not limited to the UCCI subnetwork, any other neural network based postprocessing module might also be used.

An exemplary implementation of the present disclosure is depicted in the FIG. 7 (the decoding process). The framework comprises two branches for luma and chroma components respectively. In each of the branch, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵₐᵥ.

After the residual latent is obtained, a recursive prediction operation is performed to obtain the latent ŷ and ŷᵤᵥ. The following steps describe how to obtain the samples of latent ŷ[:, i, j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:, i, j].
4. The mean value mean[:, i, j] and the quantized residual latent ŵ[:, i, j] are added together to obtain the latent ŷ[:, i, j].
5. The steps 1-4 are repeated for the next sample.

Whether to and/or how to apply at least one method disclosed in the document may be signaled from the encoder to the decoder, e.g. in the bitstream.

Alternatively, whether to and/or how to apply at least one method disclosed in the document may be determined by the decoder based on coding information, such as dimensions, color format, etc.

Alternative or additionally, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in the FIG. 7 might be an entropy decoding module. It might be a range decoder or an arithmetic decoder or the like.

The proposed solution described herein is not limited to the specific combination of the units exemplified in FIG. 7. Some of the modules might be missing and some of the modules might be displaced in processing order. Also additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the proposed solution is not affected by the removing of one or more of the said scaling and adding modules.

In FIG. 7, other operations that are performed during the processing of the luma and chroma components are also indicated using the star symbol. These processes are denoted as MS1, MS2, MS3+0. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

In one example the primary and secondary color components of an image are coded separately, using networks with similar architecture, but different number of channels as shown in 8. All boxes with same names are sub-networks with the similar architecture, only input-output tensor size and number of channels are different. Number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

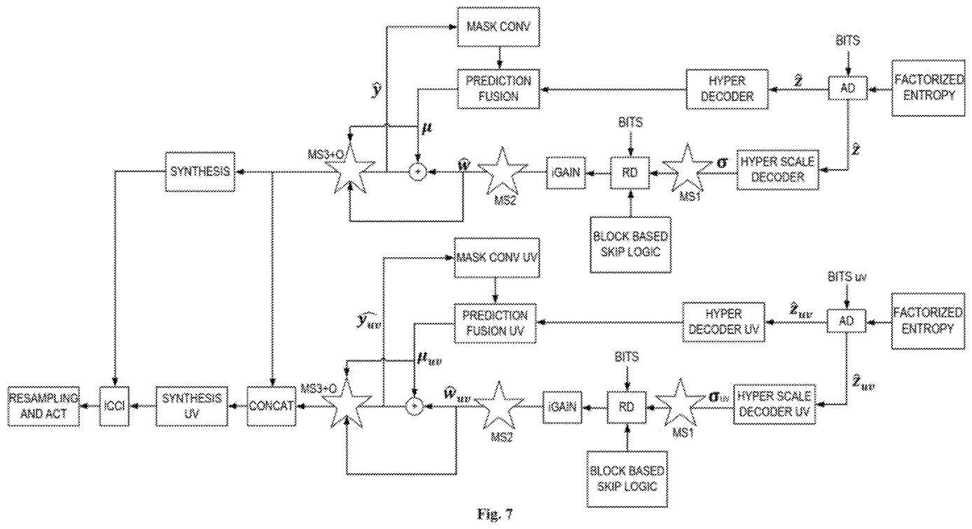

FIG. 8 illustrates learning-based image codec architecture.

First the input image that has RGB color format is converted to primary (Y) and secondary components (UV). The primary component x_{Y} is coded independently from secondary components x_{UV} and the coded picture size is equal to input/decoded picture size. The secondary components are coded conditionally, using x_{Y} as auxiliary information from primary component for encoding x_{UV} and using ŷ_{Y} as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{Y}, x_{UV} goes through a module which adjusts the sample location by down-sampling (marked as “s↓” on FIG. 8), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s↑” on FIG. 8), which outputs secondary components up-sampled with factor s.

The example in FIG. 8 exemplifies an image coding system, where the input image is first transformed into primary (Y) and secondary components (UV). The outputs \hat{x}_{Y}, \hat{x}_{UV} are the reconstructed outputs corresponding to the primary and secondary components. At the and of the processing, \hat{x}_{Y}, \hat{x}_{UV} are converted back to RGB color format. Typically the x_{UV} is downsampled (resized) before processing with the encoding and decoding modules (neural networks). For example the size of the x_{UV} might be reduced by a factor of 50% in each of the vertical and horizontal dimensions. Therefore the processing of the secondary component includes approximately 50%×50%=25% less samples, therefore it is computationally less complex.

### 2.8 Cropping Operation in Neural Network Based Coding

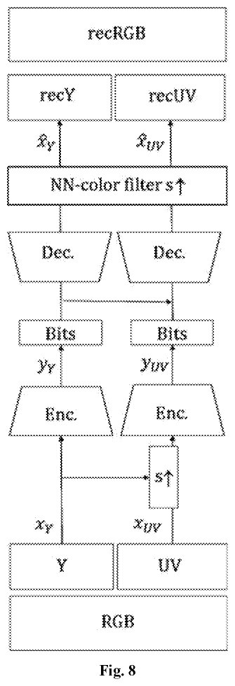

FIG. 9 illustrates synthesis transform example for learning based image coding.

The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.

The cropping layer changes tensor size h_{d}×w_{d} to h_{d-1}×w_{d-1}, where h_{d}=2·ceil(H/2^{d}); w_{d}=2·ceil(W/2^{d}); here d is the depth of proceeding convolution in the codec architecture. For primary component Synthesis Transform receives input tensor with size h×w; h=ceil(H/16); w=ceil(W/16). The output of Synthesis Transform for primary component is 1×h₀×w₀, where h₀=H; h₀=W.

For secondary component Synthesis Transform receives input tensor with size h_{UV}×w_{UV}; h_{UV}=ceil(ceil(H/s)/16); w_{UV}=ceil(ceil(W/s)/16). The output of the Synthesis Transform for primary component is 2×h_{UV0}×w_{UV0}, where h_{UV0}=ceil(H/s); h_{UV0}=ceil(W/s). For secondary components input sizes are h₀=ceil(H/s); w₀=ceil(W/s), where s is the scale factor. The scale factor might be 2 for example, wherein the secondary component is downsampled by a factor of 2.

Based on the above explanation, the operation of the cropping layers depend on the output size H, W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil(W/2¹), which means if the input of this second cropping layer is greater than h1, w1 in any dimension, than cropping is applied in that dimension. In summary, the operation of cropping layers are controlled by the output size H, W. In one example if H and W are both equal to 16, then the cropping layers do not perform any cropping. On the other hand if H and W are both equal to 17, then all 4 cropping layers are going to perform cropping.

### 2.9 Bitwise Shifting

The bitwise shift operator can be represented using the function bitshift(x, n), where n is an integer number. If n is greater than 0, it corresponds to right-shift operator (>>), which moves the bits of of the input to the right, and the left-shift operator (<<), which moves the bits to the left. In another words the bitshift(x, n) operation corresponds to:

$$bitshift ( x , n ) = x * {2}^{n} , or$$

$$bitshift ( x , n ) = floor ( x * {2}^{n} ) , or$$

$$bitshift ( x , n ) = x / / {2}^{n} .$$

The output of the bitshift operation is an integer value. In some implementations, the floor( ) function might be added to the definition.

Floor(x) is equal to the largest integer less than or equal to x.

The “//” operator or the integer division operator: It is an operation that comprises division and truncation of the result toward zero. For example, 7/4 and −7/−4 are truncated to 1 and −7/4 and 7/−4 are truncated to −1.

$$rightshift ( x , n ) = x ≫ n or$$

$$leftshift ( x , n ) = x ≪ n$$

Equation 3: alternative implementation of the bitshift operator as rightshift or leftshift.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### 2.10 Convolution Operation

The convolution is a fairly simple operation at heart: you start with a kernel, which is simply a small matrix of weights. This kernel “slides” over the input data, performing an elementwise multiplication with the part of the input it is currently on, and then summing up the results into a single output pixel. In some cases the convolution operation might comprise a “bias”, which is added to the output of the elementwise multiplication operation. The convolution operation might be described by the following mathematical formula. An output out1 can be obtained as:

$$out 1 [ x , y ] = conv 1 ( I ) = {\sum }_{k = 0}^{M} {\sum }_{i = 0}^{N} {\sum }_{j = 0}^{P} w {1}_{k} [ i , j ] \times {I}_{k} [ x + i , y + j ] + K 1$$

wherein w1 are the multiplication factors, K1 is called a bias (an additive term) and Iₖ is the k^{th} input, and N is the kernel size in one direction and P is the kernel size in another direction. The convolution layer might consist of convolution operations wherein more than one output might be generated. Other equivalent depictions of the convolution operation might be found below:

$$out 1 [ x , y ] = conv 1 ( I ) = {\sum }_{k = 0}^{M} {\sum }_{i = 0}^{N} {\sum }_{j = 0}^{P} w 1 [ k , i , j ] \times I [ k , x + i , y + j ] + K 1$$

$$out [ c , x , y ] = conv ( I ) = {\sum }_{k = 0}^{M} {\sum }_{i = 0}^{N} {\sum }_{j = 0}^{P} w [ c , k , i , j ] \times I [ k , x + i , y + j ] + K [ c ]$$

In the above equations “c” indicates the channel number. It is equivalent to output number, out[1,x,y] is one output and out[2,x,y] is a second output. Wherein the k is the input number, I[1, x, y] is one input and I[2, x, y] is a second input.

The w1, or w describe weights of the convolution operation.

### 2.11 Leaky_Relu Activation Function

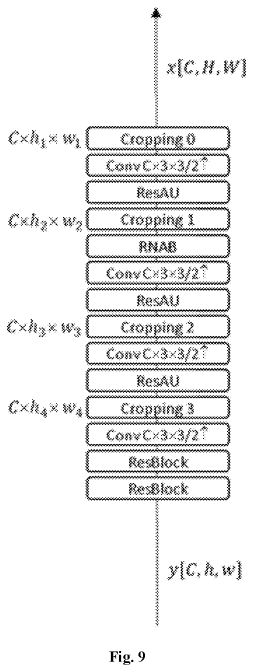

FIG. 10 illustrates Leaky Relu activation function.

The leaky_relu activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the leaky_relu function.

### 2.12 Relu Activation Function

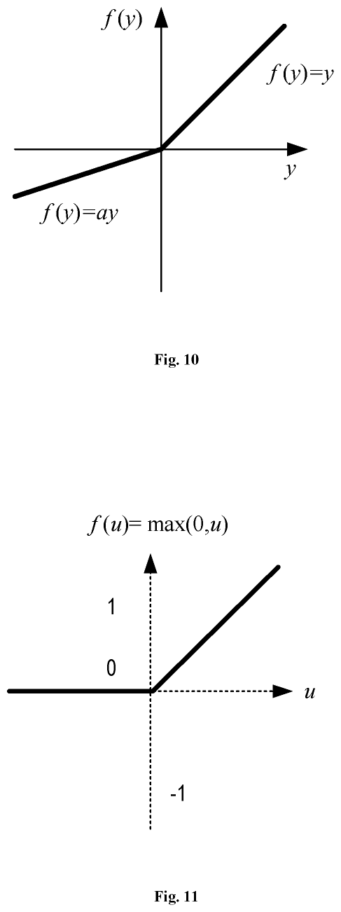

The relu activation function is depicted in FIG. 11. According to the function, if the input is a positive value, the output is equal to the input. If the input (y) is a negative value, the output is equal to 0.

### 2.13 the JPEG AI Image Coding Standard

The design in the latest JPEG AI draft specification utilizes some NN-based image coding methods described mentioned above. Some of the features in the latest JPEG AI specification are described or summarized below.

### 2.13.1 Bitstream Structure

The structure of a JPEG AI bitstream (also referred to as code stream or codestream) is composed of six parts with byte boundary, which are:
1) Start Of Codestream (SOC) marker;
2) Picture header;
3) Codestream of hyper tensor z, including \hat{z}_{Y} and \hat{z}_{UV};
4) Codestream of primary component residual, which includes \hat{r}_{Y};
5) Codestream of secondary component residual, which includes \hat{r}_{UV};
6) End Of Codestream (EOC) marker.

The overall syntax structure of an image is:

| | Descriptor |
|---|---|
| picture( ) { | |
| SOC | u(16) |
| picture_header( ) | |
| z_stream( ) | |
| r_primary_stream( ) | |
| r_secondary_stream( ) | |
| EOC | u(16) |
| } | |

### 2.13.2 Picture Header

This sub-stream contains information about image height H, width W, latent space tiles location and sizes, control flags for each tool, scaling factors for primary and secondary component, modelIdx—learnable model index and displacement for rate control parameters (β_Y for primary and β_UV for secondary component).

The syntax and semantics are as follows:

| | Descriptor |
|---|---|
| picture_header( ) { | |
| PIH | u(16) |
| picture_header_size | u(16) |
| img_width | u(16) |
| img_height | u(16) |
| picture_format | u(2) |
| bit_depth | u(1) |
| res_changer_header( ) | |
| icc_profile_header( ) | |
| model_header( ) | |
| EFE_upsampler_parameters ( ) | |
| ICCI_header( ) | |
| EFE_nonlinear_filter_parameters ( ) | |
| LEF_parameters( ) | |
| } | |

. . .
picture_header_size is the number of bytes in the picture header excluding the first two-byte marker;
img_width plus 64 specifies width of an input picture (from 64 to 65600);
img_height plus 64 specifies height of the input picture (from 64 to 65600);
picture_format is a data format of the output picture (YUV420=0, YUV444=1, sRGB=2, YUV444=3);
bit_depth is a bit-depth the output picture (“0” corresponds to 8 and “1” corresponds to 10);
. . .
tile_signaling_type is a type of signalling tiling information. When not present, the value of tile_signaling_type is inferred to be equal to 0.
tile_enable_Luma and tile_enable_Chroma are enable flags for tiling of primary and secondary components.
tile_size_Luma and tile_size_Chroma are size of tiles for primary and secondary components.
tile_overlap_Luma and tile_overlap_Luma are sizes of tiles overlapping areas for primary and secondary components.
. . .

### Skip Mode

Skip Mode allows skip writing to/parsing from the bit-stream residual tensor elements which can be identified by encoder and decoder to be zeros.

### Cube Flag Generation

The input of Cube Flag generation process is
h₄ latent space tensor height,
w₄ latent space tensor width,
cube_flag[NumCubeFlag], where NumCubeFlag=((h₄+7)>>3)·((w₄+7)>>3).

The output of Cube Flag generation process is
cube_flag_skip[C, h₄, w₄].

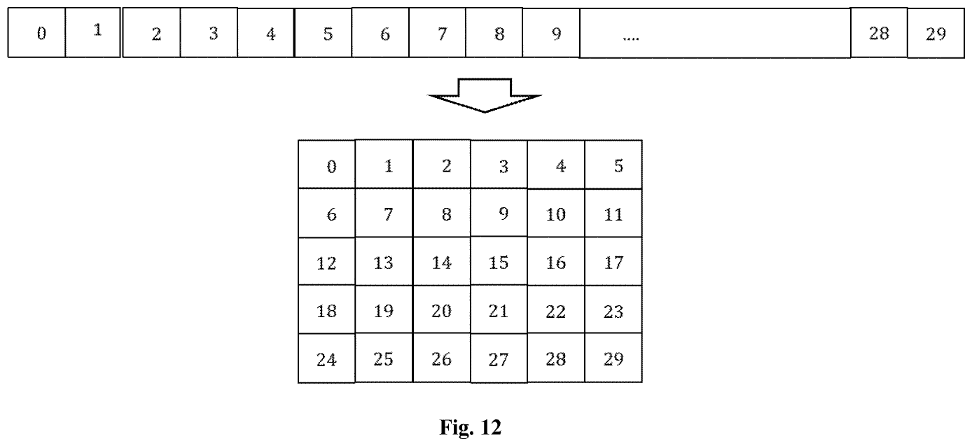

The cube size is C×8×8, the 1D arrays cube_flag is represent a 2D array with height h and width w in raster scan order (an example is shown in FIG. 12), where h=(h₄+7)>>3, w=(w₄+7)>>3.

For each element (c, i, j), cube_flag_skip[c, i, j]=cube_flag[w·(i>>3)+(j>>3)].

### SKIP Mask Generation

The input of SKIP Mask generation process
log domain standard deviation tensor I_{σ}′[C,h₄,w₄] after Sigma Scale (10.4);
compIdx: 0—primary (y) or 1—secondary (uv);
cube_luma_flag [C, h₄, w₄] if (compIdx==0) or cube_chroma_flag [C, h₄, w₄] if (compIdx==1);

The output of SKIP Mask generation process is
mask_skip[C,h₄,w₄].

First cube_flag_skip tensor fo size [C, h₄, w₄] generated as described in section 13.3.1, using (compIdx==0)? cube_luma_flag: cube_chroma_flag as input.

The following ordered steps are applied:
Each one of the sigma samples is compared with the threshold_skip which is equal to 382 for all model_id. The comparison is stored in a mask tensor mask_skip of size [C, h₄, w₄].

$$mask\_skip [ c , i , j ] = \{ \begin{matrix}True if {I}_{σ}^{′} [ c , i , j ] > threshold\_skip \\ False\end{matrix} .$$

Then additionally mask_skip[c, i, j]=mask_skip[c, i, j]∪(!cube_flag_skip[c, i, j]).

### Encoder Side SKIP Operations

This process is performed at encoder side only.

At the encoder, the inputs of skip mode process are
the residual tensor \hat{r}[C,h₄,w₄].
mask_skip[C,h₄,w₄].

The output of this process is
1D array s[num_res_elements] to be encoded by me-tANS encoder (0) to the “stream−y”.

The process of residual skip mode at the encoder is as follows:
Dimensions [C, h₄, w₄] are set equal to number of channels, height and width of the sigma tensor σ (Table 2).
The counter k=0.
The following ordered steps are applied:
For c=0 . . . C−1, i=0 . . . h₄−1, j=0 . . . w₄−1

$$\hat{r} [ c , i , j ] = ( mask\_skip [ c , i , j ] == True ) ? \hat{r} [ c , i , j ] : 0 ,$$

$$If ( mask\_skip [ c , i , j ] == True ) s [ k ] = \hat{r} [ c , i , j ] ,$$

$$k = k + mask\_skip [ c , i , j ] .$$

The output array size num_res_elements set to the counter value: num_res_elements=k.

### Decoder Side SKIP Operation

At the decoder, the inputs of skip mode process are
1D array s[num_res_elements] after decoding by me-tANS (section 9.4.2) to from the “stream−y”,
mask_skip[C,h₄,w₄].

The output of this process is
the residual tensor \hat{r}[C,h₄,w₄].

The output of the lossless decoding process is a 1D array {sₖ}, whose size is equal to the total number of “1”s in the mask_skip [C,h₄,w₄] tensor.

In other words, the mask_skip [C,h₄,w₄] tensor determines which samples of the residual tensor \hat{r} are included in the bitstream. All of the other samples of the quantized residual tensor are inferred to be equal to zero.

The process of residual skip mode at the decoder is as follows:
Dimensions [C, h₄, w₄] are set equal to number of channels, height and width of the sigma tensor σ (Table 2).
Tensors \hat{r}[C,h₄,w₄] and maskAggregate [C,h₄,w₄] are initialized to be equal to all zeros and all ones respectively.
The counter k=0.
The following ordered steps are applied:
For c=0 . . . C−1, i=0 . . . h₄−1, j=0 . . . w₄−1

$$\hat{r} [ c , i , j ] = mask\_skip [ c , i , j ] \cdot ( s [ k ] - {2}^{16 - 1} + 1 ) , k = k + 1.$$

### Hyper Tensor Decoding

The input of this process is
hypertensors codestream.

The output of this process is two tensors
z_primary (\hat{z}_{Y}) is a two dimensional tensor, with the first dimension as and the second dimension as z_primary_width*z_pnmary_height;
z_secondary (\hat{z}_{UV}) is a two dimensional tensor, with the first dimension as z_secondary_ch and the second dimension as z_secondary_width*z_secondary_height.

Here z_primary_ch=Cₚ, z_primary_width=w_{6Y}, z_primary_height=h_{6Y}, and z_secondary_ch=C_{S}, z_secondary_width=w_{6UV}, z_secondary_height=h_{6UV} as defined in Table 2.

### Syntax Table of Hyper Tensor

| | Descriptor |
|---|---|
| z_stream( ) { | |
| SOZ | u(32) |
| num_threads_z | u(8) |
| for (i =1; i < num_threads_z; ++i) { | |
| thread_offsets_z[i] | u(24) |
| } | |
| for (i =0; i < num_threads_z; ++i) { | |
| sub_stream[i]=sub_stream_init(i, num_threads_z, thread_offsets_z, z_stream_size) | |
| } | |
| for (ch =0; ch < z_primary_ch; ++ch) { | |
| for (i =0; i < num_threads_z; ++i) { | |
| decode_z_data(sub_stream[i], z_primary[ch][ ], ch, z_primary_width, z_primary_height, | |
| i, num_threads_z) | |
| } | |
| } | |
| for (ch =0; ch < z_secondary_ch; ++ch) { | |
| for (i =0; i < num_threads_z; ++i) { | |
| decode_z_data(sub_stream[i], z_secondary[ch][ ], ch, z_secondary_width, | |
| z_secondary_height, i, num_threads_z) | |
| } | |
| } | |
| } | |

### Semantics of Hyper Tensor

SOZ is 32-bits marker which includes type (first two-bytes) and hyper code stream size (last two-bytes);
   z_stream_size is the number of bytes in the hyper tensor codestream excluding the first two-byte marker;
num_threads_z is the number of parallelly decodable sub-stream in the hyper tensor codestream; the maximum value of num_threads_z is 128.
thread_offset_z[i] is the number of bytes between the start of the hyper tensor sub-stream i and the start of the hyper tensor codestream (excluding the first two-byte marker).

### Primary Residual Stream Decoder

The input of this process is
Primary component residual codestream;
sigma_Idx_primary—tensor of size [Cₚ, h_{4Y}, w_{4Y}] which is the output of Sigma quantization (section 10.8) for primary component.

The output of this process is
decoded—one dimensional array {s} of residual tensor elements which is an input of decoder skip process (section 13.3.4) for primary component.

Here sizes Cₚ, w_{4Y}, h_{4Y} are defined in Table 2.

### Syntax Table of Primary Residual Tenser

| | Descriptor |
|---|---|
| r_primary_stream( ) { | |
| SOR | u(16) |
| r_primary_stream_size | u(32) |
| num_threads_r_primary | u(8) |
| for (i =1; i < num_threads_r_primary; ++i) { | |
| thread_offsets_r_primary[i] | u(32) |
| } | |
| for (i=0; i < num_threads_r_primary; ++i) { | |
| sub_stream[i]=sub_stream_init(i, num_threads_r_primary, thread_offsets_r_primary, | |
| r_primary_stream_size) | |
| decode_r_data(sub_stream[i], r_primary[ ], sigma_Idx_primary[ ], i, num_threads_r_primary) | |
| } | |
| } | |

### Semantics of Primary Residual Tensor

r_primary_stream_size is the number of bytes in the primary component residual tensor codestream excluding the first two-byte marker;
num_threads_r_primary is the number of parallelly decodable sub-stream in primary component residual tensor codestream; the maximum value of num_threads_r_primary is 128 and is dependens on profiles and levels;
thread_offsets_r_primary[i] is the number of bytes between the start of the primary component residual tensor sub-stream i and the start of the primary component residual tensor codestream (excluding the first two-byte marker).

### Secondary Residual Stream Decoder

The input of this process is
Codestream for secondary component residual;
sigma_Idx_secondary—tensor of size [C_{S}, h_{4UV}, w_{4UV}] which is the output of Sigma quantization (section 10.8) for primary component.

The output of this process is
decoded—one dimensional array {s} of residual tensor elements which is an input of decoder skip process (section 13.3.4) for secondary component.

Here sizes C_{S}, h_{4UV}, w_{4UV} are defined in Table 2.

### Syntax Table of Secondary Residual Tensor

| | Descriptor |
|---|---|
| r_secondary_stream( ) { | |
| SOR | u(16) |
| r_secondary_stream_size | u(24) |
| num_threads_r_secondary | u(8) |
| for (i =1; i < num_threads_r_secondary; ++i) { | |
| thread_offsets_r_secondary[i] | u(24) |
| } | |
| for (i=0; i < num_threads_r_secondary; ++i) { | |
| sub_stream[i]=sub_stream_init(i, num_threads_r_secondary, thread_offsets_r_secondary, | |
| r_secondary_stream_size) | |
| decode_r_data(sub_stream[i], r_secondary[ ], sigma_Idx_secondary[ ], i, | |
| num_threads_r_secondary) | |
| } | |
| } | |

### Semantics of Secondary Residual Tensor

r_secondary_stream_size is the number of bytes in the secondary component residual tensor codestream excluding the first two-byte marker;
num_threads_r_secondary is the number of parallelly decodable sub-stream in secondary component residual tensor codestream; the maximum value of num_threads_r_secondary is 128 and is dependens on profiles and levels;
thread_offsets_r_secondary[i] is the number of bytes between the start of the secondary component residual tensor sub-stream i and the start of the secondary component residual tensor codestream (excluding the first two-byte marker).

### 3. PROBLEMS

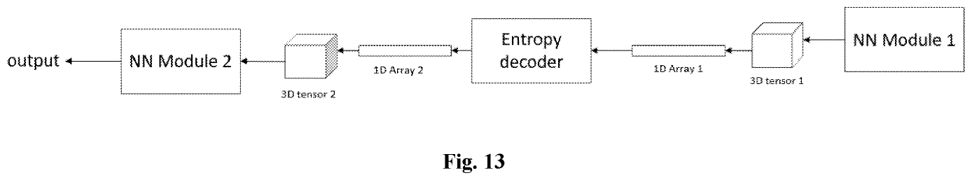

The design in the latest JPEG AI draft specification is in JPEG output document has the following problems: The problem can be described using FIG. 13. The FIG. 13 describes the structure of a Neural Network based decoder. The decoder first generates a first 3D tensor (3D tensor 1), which comprises probability parameters (e.g. gaussian scale parameters). Afterwards the 3D tensor is converted to a 1D array, which is used as input to the entropy decoder module. The entropy decoder decodes a bitstream, and outputs a 1D array (1D array 2). The 1D array2 is then converted to a 3D tensor (3d Tensor 2), which is used as input to NN Module 2, which outputs the reconstructed picture.

The problem of the state of the art is, the conversion process from 1D array to 3D tensor, and back is not defined. In other words which sample of 3D tensor corresponds to which sample of 1D array is not defined. Since such definition is missing, 2 different decoders manufactured by 2 different manufacturers might obtain a different output, and in extreme cases the output picture (reconstructed picture) might be totally corrupted.

### 4. DETAILED SOLUTIONS

An indication signaled in the bitstream may be denoted as a syntax element (SE).

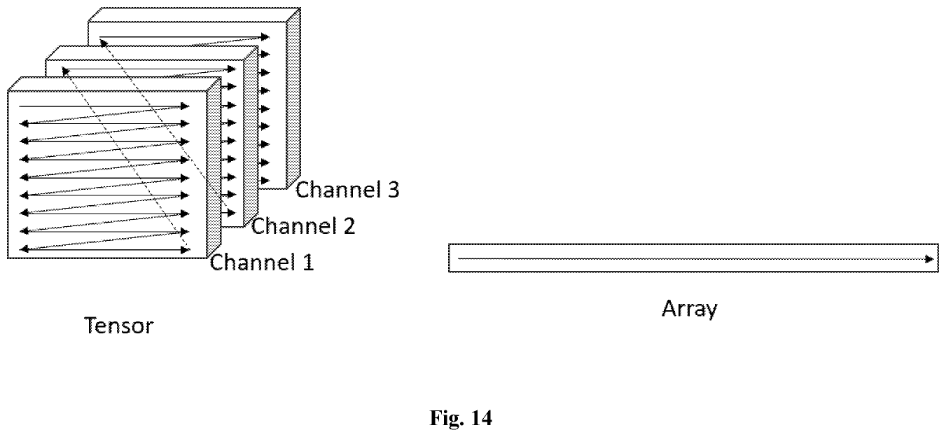

According to some embodiments of the present disclosure:
1. A data type conversion might be applied during the conversion of a bitstream to reconstructed image.
   a. The data type conversion might be between an array and a tensor.
   b. The data type conversion might be according to an order.
   c. The order might be different based on the conversion direction.
      i. If an array is converted to a tensor, a first order might be applied,
      ii. If a tensor is converted to an array, a second order might be applied.
2. Conversion from 1D array to tensor might be performed according to an order.
3. Conversion from tensor to 1D array might be performed according to an order.
   a. The tensor might be 2 dimensional tensor, or a 3 dimensional tensor or a 4 dimensional tensor.
4. The conversion might be based on a raster scan order or a z-scan order.
5. The conversion might be as follows:
   a. The tensor of 3 dimensions might be spatial dimensions (height and width), and a channel dimension.
   b. First all samples of a channel might be scanned (e.g. completed) before a sample of a second channel is scanned.
   c. Within a channel, a row of samples might be scanned (e.g. completed) before a sample of a second channel is scanned.
   d. The rows might be scanned in increasing order.
   e. Within a row of samples, the samples might be scanned from left to right.
   f. The channels might be scanned in increasing order.
   g. This conversion might be depicted using the FIG. 14.
   h. An example implementation of the above scanning order might be described as:

At the decoder, the inputs of skip mode process are

| | |
|---|---|
| - | sigma_Idx[C,h₄,w₄] after Sigma quantization process as specified |
| | in section 10.8. |
| - | mask_skip[C,h₄,w₄]. |

The output of this process is

| | |
|---|---|
| - | 1 dimensional sigma_Idx_flatten[ ]. |

The following ordered steps are performed.
The viable k is set equal to 0.
For c = 0..C − 1,

| | |
|---|---|
| \| | For i = 0..h₄ − 1, |

| | |
|---|---|
| ┐ | j = 0..w₄ − 1; |

| | |
|---|---|
| ┘ | If mask_skip [c,i,j] is equal to 1, sigma_Idx_flatten[k] |
| | is set equal to sigma_Idx[c,i,j], and k is |
| | incremented by 1. |

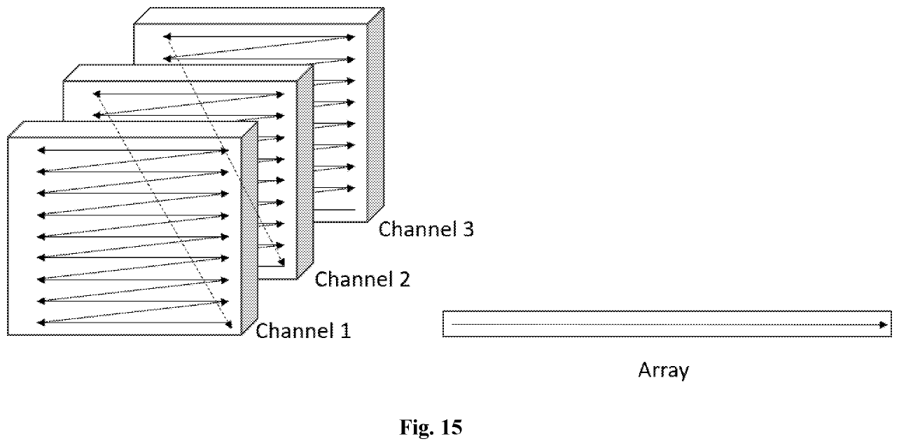

In the pseudo code above, the indices c, i and are initialized to be 0 and incremented till channel number C, height of the tensor h₄ and width of the tensor w₄
6. The conversion might be based on an inverse z-scan order:
   a. The order might be depicted using the FIG. 15.
      The samples might be scanned starting from the bottom-right of a channel.
      The above order might be described using the pseudocode below:

Decoder side SKIP operation
At the decoder, the inputs of skip mode process are

| | |
|---|---|
| - | 1D array s[num_res_elements] after decoding by me-tANS |
| | (section 9.4.2) to from the “stream − y” |
| - | mask_skip[C,h₄,w₄]. |

The output of this process is

| | |
|---|---|
| - | the residual tensor \hat{r}[C,h₄,w₄]. |

The output of the lossless decoding process is a 1D array {sₖ}, whose
size is equal to the total number of “1”s in the mask_skip [C,h₄,w₄]
tensor.
In other words, the mask_skip [C,h₄,w₄] tensor determines which
samples of the residual tensor \hat{r} are included in the bitstream. All of the
other samples of the quantized residual tensor are inferred to be
equal to zero.
The process of residual skip mode at the decoder is as follows:

| | |
|---|---|
| ┘ | Dimensions [C,h₄,w₄] are set equal to number of channels, |
| | height and width of the sigma tensor σ (Table 2). |
| ┘ | Tensors \hat{r} [C,h₄,w₄] and maskAggregate [C,h₄,w₄] are |
| | initialized to be equal to all zeros and all ones |
| | respectively. |
| \| | The counter k = 0. |
| ⊐ | The following ordered steps are applied: |
| ⊐ | For c = C − 1 ... 0., |

| | |
|---|---|
| ┘ | For i = h₄ − 1 ... 0, |

| | |
|---|---|
| ┐ | j = w₄ − 1 ... 0; |

| | |
|---|---|
| ⊐ | If mask_skip [c,i,j] is equal to 1, |
| | \hat{r}[c,i,j] is set equal to s[k], and k is |
| | incremented by 1. |
| ┘ | \hat{r}[c,i,j] is set equal to 0 otherwise. |

In the pseudo code above, the indices c, i and j are initialized to be channel number C, height of the tensor h₄−1 and width of the tensor w₄−1, and they are decremented will 0. In the meantime the array s[k] is incremented, meaning that is scanned from left to right.
Similarly in the following also the inverse z-scan order is utilized:

Input of this process is z_secondary for secondary component and
z_primary for primary component.
Output of this process is \hat{z}[C,h₆,w₆] reconstructed hyper tensor.

| ⊐ | zArray is set equal to z_primary for primary component | |
|---|---|---|
| | and z_secondary for decondary component. | |
| ⊐ | For c = 0..C | |
| | ⊐ | The variable k is set equal to 0. |
| | ┘ | For y = h₆ − 1 ... 0, x = w₆−1...0, |

| | |
|---|---|
| ┐ | \hat{z}[c,y,x] = zArray[c][k] |
| ┐ | k = k + 1. |

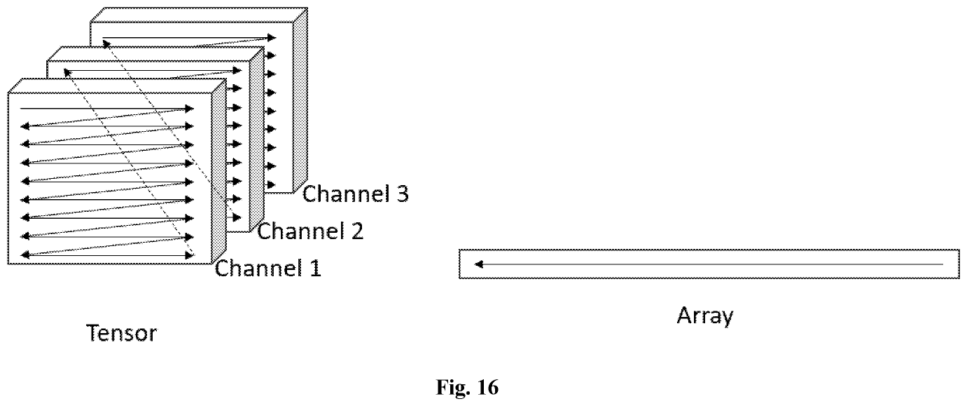

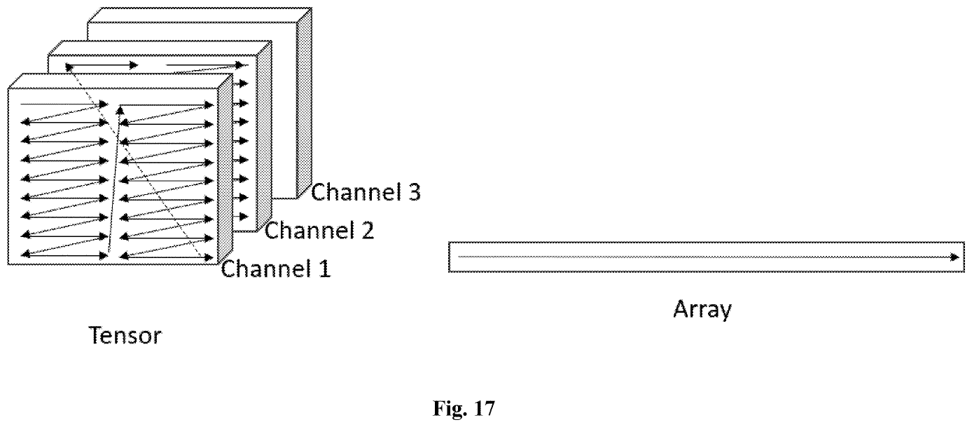

In the pseudo code above, the indices y and x are initialized to be channel height of the tensor h₆−1 and width of the tensor w₆−1, and they are decremented will 0. In the meantime the array zArray[c][k] is incremented (k is incremented), meaning that is scanned from left to right. Here the tensor is 2 and the array is zArray[c].
7. Another scan order might be described using the FIG. 16. It is noted that this scan order is equivalent to the inverse z-scan described above.
8. Z-scan and inverse z-scan processes that are described above might be applied on the whole or part of a tensor. In the FIG. 17, part of a channel is scanned first, before a sample of the second part is scanned. Inside the part of the channel however z-scan is utilized.
9. The tensor might be a residual tensor or a hyper tensor or a latent tensor, or a sigma tensor or a tensor comprising probability parameter samples, or a tensor comprising indices.
10. The 1D array might be a bitstream or an array comprising hyper latent samples or residual samples or probability parameter samples or indices.
11. Whether to and/or how to do the conversion may be signaled by at least one SE in the bitstream.
12. Whether to and/or how to do the conversion may be profile-dependent.

### General Aspects

13. A syntax element disclosed above may be binarized as a flag, a fixed length code, an EG(x) code, a unary code, a truncated unary code, a truncated binary code, etc. It can be signed or unsigned.
14. A syntax element representing a coding tool or a coding method may not be signalled and implicitly determined to be unused, if the coding tool or the coding method is regarded as not applicable or cannot be used.
15. A syntax element disclosed above may be coded with at least one context model. Or it may be bypass coded.
16. A syntax element disclosed above may be signaled in a conditional way.
   a. The SE is signaled only if the corresponding function is applicable.
   b. The SE is signaled only if the dimensions (width and/or height) of the block satisfy a condition.

### 5. EMBODIMENTS

Below are some example embodiments for the detailed solutions aspects summarized above in Section 4.

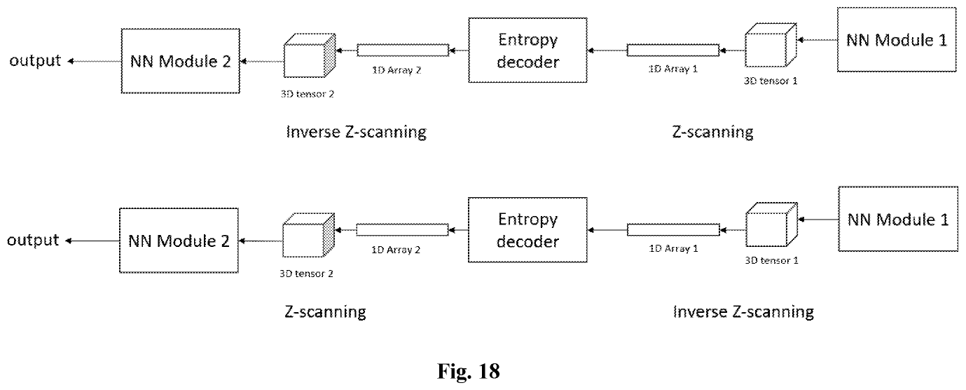

The FIG. 18 exemplify an embodiment according to the present disclosure.

According to an embodiment, a bitstream might converted to a reconstructed image using an NN network as follows:
a first NN module is used to obtain a tensor, and the tensor is converted to an array of 1 dimension using an z-scan order.
The said 1D array is used by an entropy decoder module to obtain a second 1D array (1D array2).
Alternatively or additionally the second 1D array “1D array 2” is converted to a tensor using inverse z-scan order, which is then used by a second NN Module to obtain the reconstructed picture.

According to an embodiment, a bitstream might converted to a reconstructed image using an NN network as follows:
a first NN module is used to obtain a tensor, and the tensor is converted to an array of 1 dimension using an inverse z-scan order.
The said 1D array is used by an entropy decoder module to obtain a second 1D array (1D array2).
Alternatively or additionally the second 1D array “1D array 2” is converted to a tensor using z-scan order, which is then used by a second NN Module to obtain the reconstructed picture.

The below are example implementation of the present disclosure. In the examples below,
The “Decoder side Sigma SKIP operation” describes a scanning order that corresponds to conversion of a tensor to an array.
“Hyper Tensor reconstruction at decoder” and “Decoder side SKIP operation” describe a scanning order that corresponds to conversion of an array to a tensor.

### Decoder Side Sigma SKIP Operation

At the decoder, the inputs of skip mode process are
sigma_Idx[C,h₄,w₄] after Sigma quantization process as specified in section 10.8.
mask_skip[C,h₄,w₄].

The output of this process is
1 dimensional sigma_Idx_flatten[ ].

The following ordered steps are performed.

The viable k is set equal to 0.
For c=0 . . . C−1,
   For i=0 . . . h₄−1,
      j=0 . . . w₄−1;
         If mask_skip [c, i, j] is equal to 1, sigma_Idx_flatten[k] is set equal to sigma_Idx[c,i,j], and k is incremented by 1.

### Hyper Tensor Reconstruction at Decoder

Input of this process is z_secondary for secondary component and z_primary for primary component. Output of this ptocess is \hat{z}[C, h₆, w₆] reconstructed hyper tensor.
zArray is set equal to z_prmary for primary component and z_secondary for decondary component.
For c=0 . . . C
   The variable k is set equal to 0.
   For y=h₆−1 . . . 0, x=w₆−1 . . . 0,
      \hat{z}[c, y, x]=zArray[c][k]
      k=k+1.

### Decoder Side SKIP Operation

At the decoder, the inputs of skip mode process are
1D array s[num_res_elements] after decoding by me-tANS (section 9.4.2) to from the “stream−y”,
mask_skip[C,h₄,w₄].

The output of this process is
the residual tensor \hat{r}[C,h₄,w₄].

The output of the lossless decoding process is a 1D array {sₖ}, whose size is equal to the total number of “1”s in the mask_skip [C,h₄,w₄] tensor.

In other words, the mask_skip [C,h₄,w₄] tensor determines which samples of the residual tensor? are included in the bitstream. All of the other samples of the quantized residual tensor are inferred to be equal to zero.

The process of residual skip mode at the decoder is as follows:
Dimensions [C, h₄, w₄] are set equal to number of channels, height and width of the sigma tensor σ (Table 2).
Tensors \hat{r}[C,h₄,w₄] and maskAggregate [C,h₄,w₄] are initialized to be equal to all zeros and all ones respectively.
The counter k=0.
The following ordered steps are applied:
For c=0 . . . C−1,
   For i=h₄−1 . . . 0,
      j=w₄−1 . . . 0;
         If mask_skip [c, i, j] is equal to 1, \hat{r}[c, i, j] is set equal to s[k], and k is incremented by 1.
         \hat{r}[c, i, j] is set equal to 0 otherwise.

More details of the embodiments of the present disclosure will be described below which are related to neural network-based visual data coding. As used herein, the term “visual data” may refer to an image, a picture in a video, or any other visual data suitable to be coded.

As discussed above, in the existing design for neural network (NN)-based visual data coding, for performing a conversion between a multi-dimensional tensor and a one-dimensional array, the correspondence between samples of the tensor and samples of the array are not defined. Since such definition is missing, two different decoders manufactured by two different manufacturers might obtain different outputs for the conversion, and in extreme cases the output picture (i.e., reconstructed picture) of a decoder might be corrupted.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

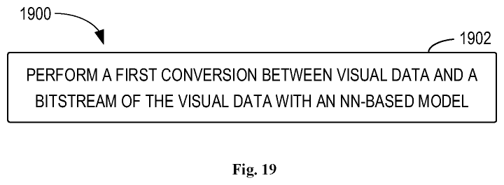

FIG. 19 illustrates a flowchart of a method 1900 for visual data processing in accordance with some embodiments of the present disclosure. At 1902, a first conversion between the visual data and a bitstream of the visual data is performed with a neural network (NN)-based model. In some embodiments, the first conversion may include encoding the visual data into the bitstream. Additionally or alternatively, the first conversion may include decoding the visual data from the bitstream. By way of example rather than limitation, the decoding model shown in FIG. 7 may be employed for decoding the visual data from the bitstream.

As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

In addition, during the first conversion, a first tensor having more than one dimension is converted to a one-dimensional first array based on a first predetermined order. The first tensor and the first array store first data associated with the visual data, and the first predetermined order indicates a correspondence between samples of the first tensor and samples of the first array. By way of example rather than limitation, the first array may be an input to an entropy coder in the NN-based model. With reference to FIG. 13, the first array may correspond to 1D array 1.

Additionally or alternatively, during the first conversion, a one-dimensional second array is converted to a second tensor having more than one dimension based on a second predetermined order. The second tensor and the second array store second data associated with the visual data, and the second predetermined order indicates a correspondence between samples of the second tensor and samples of the second array. By way of example rather than limitation, the second array may be an output of the entropy coder. With reference to FIG. 13, the second array may correspond to 1D array 2.

In some embodiments, the first data may comprise probability parameter indices for coding the visual data, samples of a residual latent representation of the visual data, samples of a hyper tensor for coding the visual data, samples of a skip mask for coding the visual data, or the like. Similarly, the second data may comprise probability parameter indices for coding the visual data, samples of a residual latent representation of the visual data, samples of a hyper tensor for coding the visual data, samples of a skip mask for coding the visual data, or the like. In addition, the second data may be different from the first data.

In some embodiments, the first tensor and/or the second tensor may have three dimensions. By way of example, the three dimensions may comprise a channel dimension and two spatial dimensions. The two spatial dimensions comprise height and width. It should be understood that the above examples are described merely for purpose of description. Instead of three dimensions, the first tensor and/or the second tensor may also have two dimensions, four dimensions, or the like. The scope of the present disclosure is not limited in this respect.

With reference to the above-mentioned section 5, in the decoder side sigma skip operation, a three-dimensional (3D) tensor sigma_Idx storing sigma indices may be converted into a one-dimensional (1D) array sigma_Idx_flatten. In the decoder side hyper tensor reconstruction, a 1D array zArray storing samples of hyper information for coding the visual data may be converted into a 3D tensor 2. Furthermore, in the decoder side skip operation, a 1D array s storing samples of the residual latent representation may be converted into a 3D tensor r.

In some embodiments, the first predetermined order may be the same as the second predetermined order. Alternatively, the first predetermined order may be different from the second predetermined order. In one example embodiment, the first predetermined order and/or the second predetermined order may be a raster scan order. For example, in the raster scan order, all samples of a first channel may be scanned before a sample of a second channel, and all samples of a first row within the first channel may be scanned before a sample of a second row within the first channel. Moreover, samples of the first row may be scanned from left to right. All rows within the first channel may be scanned from top to bottom. In addition, all channels may be scanned in an ascending order. That is, channel 2 may be scanned after channel 1, and channel 3 may be scanned after channel 2, and so on. FIG. 14 illustrates a schematic diagram of an example raster scan order.

In another example embodiment, the first predetermined order and/or the second predetermined order may be an inverse z-scan order. For example, in the inverse z-scan order, all samples of a first channel may be scanned after a sample of a second channel, all samples of a first row within the first channel may be scanned after a sample of a second row within the first channel. Moreover, samples of the first row may be scanned from right to left, and all rows within the first channel may be scanned from bottom to top. FIG. 15 illustrates a schematic diagram of an example inverse z-scan order.

In a further example embodiment, the first predetermined order and/or the second predetermined order may be a z-scan order. For example, in the z-scan order, all samples of a first channel may be scanned before a sample of a second channel, all samples of the first channel may be partitioned into a plurality of parts at least comprising a first part and a second part, all samples of the first part may be scanned before a sample of the second part, and all samples of a first row within the first part may be scanned before a sample of a second row within the first part. In other words, a scan process similar to the above-described raster scan order may be performed for each part of a channel. A schematic diagram illustrating the abovementioned z-scan order is shown in FIG. 17.

It should be understood that the possible implementations of the scan order described here are merely illustrative and therefore should not be construed as limiting the present disclosure in any way. The first predetermined order and the second predetermined order may also be implemented with any other suitable scan order, such as a scan order shown in FIG. 16, or the like.

In view of the above, the conversion between a tensor having more than one dimension and a one-dimensional array is performed based on a predetermined order which indicates a correspondence between samples of the tensor and samples of the array. Compared with the conventional solution where the scan order for such conversions is not explicitly defined, the proposed method can advantageously ensure the conversion between the multi-dimensional tensor the one-dimensional array being performed according to a same scan order at different devices. Thereby, the conversion process can be performed uniformly, and discrepancy between results of performing the conversion process at different devices can be avoided. Thereby, the coding quality can be improved.

In some embodiments, the bitstream may comprise at least one syntax element indicating at least one of the following: whether to convert the first tensor to the first array, how to convert the first tensor to the first array, whether to convert the second array to the second tensor, or how to convert the second array to the second tensor. Additionally or alternatively, at least one of the following may be dependent on a profile to which the bitstream conform: whether to convert the first tensor to the first array, how to convert the first tensor to the first array, whether to convert the second array to the second tensor, or how to convert the second array to the second tensor.

In some embodiments, any of the above-mentioned indication may be a syntax element. For example, the syntax element may be binarized as one of the following: a flag, a fixed length code, an exponential Golomb (EG) code, a unary code, a truncated unary code, or a truncated binary code. In addition, the syntax element may be coded with at least one context model. Alternatively, the syntax element may be bypass coded. In some embodiments, the syntax element may be signaled based on a condition.

In some embodiments, the syntax element may be indicated at one of the following: a block level, a sequence level, a group of pictures level, a picture level, a slice level, or a tile group level. In some embodiments, the syntax element may be indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In view of the above, the solutions in accordance with some embodiments of the present disclosure can advantageously improve coding flexibility and coding efficiency.

According to further embodiments of the present disclosure, a non-transitory computer-readable recording medium is provided. The non-transitory computer-readable recording medium stores a bitstream of visual data which is generated by a method performed by an apparatus for visual data processing. The method comprises: performing a first conversion between the visual data and the bitstream with a neural network (NN)-based model, the first conversion comprising at least one of the following: converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or converting, based on a second predetermined order, a one-dimensional second array to a second tensor having more than one dimension, the second tensor and the second array storing second data associated with the visual data, and the second predetermined order indicating a correspondence between samples of the second tensor and samples of the second array.

According to still further embodiments of the present disclosure, a method for storing bitstream of visual data is provided. The method comprises: performing a first conversion between the visual data and the bitstream with a neural network (NN)-based model, the first conversion comprising at least one of the following: converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or converting, based on a second predetermined order, a one-dimensional second array to a second tensor having more than one dimension, the second tensor and the second array storing second data associated with the visual data, and the second predetermined order indicating a correspondence between samples of the second tensor and samples of the second array; and storing the bitstream in a non-transitory computer-readable recording medium.

Implementations of the present disclosure can be described in view of the following clauses, the features of which can be combined in any reasonable manner.

Clause 1. A method for visual data processing, comprising: performing a first conversion between visual data and a bitstream of the visual data with a neural network (NN)-based model, the first conversion comprising at least one of the following: converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or converting, based on a second predetermined order, a one-dimensional second array to a second tensor having more than one dimension, the second tensor and the second array storing second data associated with the visual data, and the second predetermined order indicating a correspondence between samples of the second tensor and samples of the second array.

Clause 2. The method of clause 1, wherein the first array is an input to an entropy coder in the NN-based model, and the second array is an output of the entropy coder.

Clause 3. The method of any of clauses 1-2, wherein the first data or the second data comprises one of the following: probability parameter indices for coding the visual data, samples of a residual latent representation of the visual data, samples of a hyper tensor for coding the visual data, or samples of a skip mask for coding the visual data.

Clause 4. The method of any of clauses 1-3, wherein at least one of the first tensor or the second tensor has three dimensions.

Clause 5. The method of clause 4, wherein the three dimensions comprise a channel dimension and two spatial dimensions.

Clause 6. The method of clause 5, wherein the two spatial dimensions comprise height and width.

Clause 7. The method of any of clauses 1-6, wherein at least one of the first predetermined order or the second predetermined order is a raster scan order.

Clause 8. The method of clause 7, wherein in the raster scan order, all samples of a first channel are scanned before a sample of a second channel, and all samples of a first row within the first channel are scanned before a sample of a second row within the first channel.

Clause 9. The method of clause 8, wherein samples of the first row are scanned from left to right.

Clause 10. The method of any of clauses 8-9, wherein all rows within the first channel are scanned from top to bottom.

Clause 11. The method of any of clauses 8-10, wherein all channels are scanned in an ascending order.

Clause 12. The method of any of clauses 1-6, wherein at least one of the first predetermined order or the second predetermined order is an inverse z-scan order.

Clause 13. The method of clause 12, wherein in the inverse z-scan order, all samples of a first channel are scanned after a sample of a second channel, all samples of a first row within the first channel are scanned after a sample of a second row within the first channel, samples of the first row are scanned from right to left, and all rows within the first channel are scanned from bottom to top.

Clause 14. The method of any of clauses 1-6, wherein at least one of the first predetermined order or the second predetermined order is a z-scan order.

Clause 15. The method of clause 14, wherein in the z-scan order, all samples of a first channel are scanned before a sample of a second channel, all samples of the first channel are partitioned into a plurality of parts at least comprising a first part and a second part, all samples of the first part are scanned before a sample of the second part, and all samples of a first row within the first part is scanned before a sample of a second row within the first part.

Clause 16. The method of any of clauses 1-15, wherein the first predetermined order is the same as the second predetermined order, or the first predetermined order is different from the second predetermined order.

Clause 17. The method of any of clauses 1-16, wherein the bitstream comprises at least one syntax element indicating at least one of the following: whether to convert the first tensor to the first array, how to convert the first tensor to the first array, whether to convert the second array to the second tensor, or how to convert the second array to the second tensor.

Clause 18. The method of any of clauses 1-16, wherein at least one of the following is dependent on a profile to which the bitstream conform: whether to convert the first tensor to the first array, how to convert the first tensor to the first array, whether to convert the second array to the second tensor, or how to convert the second array to the second tensor.

Clause 19. The method of any of clauses 1-18, wherein the visual data comprise a video, a picture of the video, or an image.

Clause 20. The method of any of clauses 1-19, wherein the first conversion includes encoding the visual data into the bitstream.

Clause 21. The method of any of clauses 1-19, wherein the first conversion includes decoding the visual data from the bitstream.

Clause 22. An apparatus for visual data processing comprising a processor and a non-transitory memory with instructions thereon, wherein the instructions upon execution by the processor, cause the processor to perform a method in accordance with any of clauses 1-21.

Clause 23. A non-transitory computer-readable storage medium storing instructions that cause a processor to perform a method in accordance with any of clauses 1-21.

Clause 24. A non-transitory computer-readable recording medium storing a bitstream of visual data which is generated by a method performed by an apparatus for visual data processing, wherein the method comprises: performing a first conversion between the visual data and the bitstream with a neural network (NN)-based model, the first conversion comprising at least one of the following: converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or converting, based on a second predetermined order, a one-dimensional second array to a second tensor having more than one dimension, the second tensor and the second array storing second data associated with the visual data, and the second predetermined order indicating a correspondence between samples of the second tensor and samples of the second array.

Clause 25. A method for storing a bitstream of visual data, comprising: performing a first conversion between the visual data and the bitstream with a neural network (NN)-based model, the first conversion comprising at least one of the following: converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or converting, based on a second predetermined order, a one-dimensional second array to a second tensor having more than one dimension, the second tensor and the second array storing second data associated with the visual data, and the second predetermined order indicating a correspondence between samples of the second tensor and samples of the second array; and storing the bitstream in a non-transitory computer-readable recording medium.

### Example Device

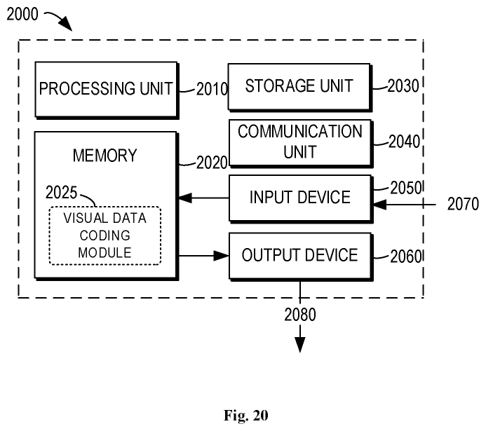

FIG. 20 illustrates a block diagram of a computing device 2000 in which various embodiments of the present disclosure can be implemented. The computing device 2000 may be implemented as or included in the source device 110 (or the visual data encoder 114) or the destination device 120 (or the visual data decoder 124).

It would be appreciated that the computing device 2000 shown in FIG. 20 is merely for purpose of illustration, without suggesting any limitation to the functions and scopes of the embodiments of the present disclosure in any manner.

As shown in FIG. 20, the computing device 2000 includes a general-purpose computing device 2000. The computing device 2000 may at least comprise one or more processors or processing units 2010, a memory 2020, a storage unit 2030, one or more communication units 2040, one or more input devices 2050, and one or more output devices 2060.

In some embodiments, the computing device 2000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2000 can support any type of interface to a user (such as “wearable” circuitry and the like).

The processing unit 2010 may be a physical or virtual processor and can implement various processes based on programs stored in the memory 2020. In a multi-processor system, multiple processing units execute computer executable instructions in parallel so as to improve the parallel processing capability of the computing device 2000. The processing unit 2010 may also be referred to as a central processing unit (CPU), a microprocessor, a controller or a microcontroller.

The computing device 2000 typically includes various computer storage medium. Such medium can be any medium accessible by the computing device 2000, including, but not limited to, volatile and non-volatile medium, or detachable and non-detachable medium. The memory 2020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2030 may be any detachable or non-detachable medium and may include a machine-readable medium such as a memory, flash memory drive, magnetic disk or another other media, which can be used for storing information and/or visual data and can be accessed in the computing device 2000.

The computing device 2000 may further include additional detachable/non-detachable, volatile/non-volatile memory medium. Although not shown in FIG. 20, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 2040 communicates with a further computing device via the communication medium. In addition, the functions of the components in the computing device 2000 can be implemented by a single computing cluster or multiple computing machines that can communicate via communication connections. Therefore, the computing device 2000 can operate in a networked environment using a logical connection with one or more other servers, networked personal computers (PCs) or further general network nodes.

The input device 2050 may be one or more of a variety of input devices, such as a mouse, keyboard, tracking ball, voice-input device, and the like. The output device 2060 may be one or more of a variety of output devices, such as a display, loudspeaker, printer, and the like. By means of the communication unit 2040, the computing device 2000 can further communicate with one or more external devices (not shown) such as the storage devices and display device, with one or more devices enabling the user to interact with the computing device 2000, or any devices (such as a network card, a modem and the like) enabling the computing device 2000 to communicate with one or more other computing devices, if required. Such communication can be performed via input/output (I/O) interfaces (not shown).

In some embodiments, instead of being integrated in a single device, some or all components of the computing device 2000 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2000 may be used to implement visual data encoding/decoding in embodiments of the present disclosure. The memory 2020 may include one or more visual data coding modules 2025 having one or more program instructions. These modules are accessible and executable by the processing unit 2010 to perform the functionalities of the various embodiments described herein.

In the example embodiments of performing visual data encoding, the input device 2050 may receive visual data as an input 2070 to be encoded. The visual data may be processed, for example, by the visual data coding module 2025, to generate an encoded bitstream. The encoded bitstream may be provided via the output device 2060 as an output 2080.

In the example embodiments of performing visual data decoding, the input device 2050 may receive an encoded bitstream as the input 2070. The encoded bitstream may be processed, for example, by the visual data coding module 2025, to generate decoded visual data. The decoded visual data may be provided via the output device 2060 as the output 2080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
performing a first conversion between visual data and a bitstream of the visual data with a neural network (NN)-based model, the first conversion comprising at least one of the following:
converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or
converting, based on a second predetermined order, a one-dimensional second array to a second tensor having more than one dimension, the second tensor and the second array storing second data associated with the visual data, and the second predetermined order indicating a correspondence between samples of the second tensor and samples of the second array.

2. The method of claim 1, wherein the first array is an input to an entropy coder in the NN-based model, and the second array is an output of the entropy coder.

3. The method of claim 1, wherein the first data or the second data comprises one of the following:
probability parameter indices for coding the visual data,
samples of a residual latent representation of the visual data,
samples of a hyper tensor for coding the visual data, or
samples of a skip mask for coding the visual data.

4. The method of claim 1, wherein at least one of the first tensor or the second tensor has three dimensions.

5. The method of claim 4, wherein the three dimensions comprise a channel dimension and two spatial dimensions.

6. The method of claim 5, wherein the two spatial dimensions comprise height and width.

7. The method of claim 1, wherein at least one of the first predetermined order or the second predetermined order is a raster scan order.

8. The method of claim 7, wherein in the raster scan order, all samples of a first channel are scanned before a sample of a second channel, and all samples of a first row within the first channel are scanned before a sample of a second row within the first channel.

9. The method of claim 8, wherein samples of the first row are scanned from left to right.

10. The method of claim 8, wherein all rows within the first channel are scanned from top to bottom.

11. The method of claim 8, wherein all channels are scanned in an ascending order.

12. The method of claim 1, wherein the visual data comprise a video, a picture of the video, or an image.

13. The method of claim 1, wherein the first conversion includes encoding the visual data into the bitstream.

14. The method of claim 1, wherein the first conversion includes decoding the visual data from the bitstream.

15. The method of claim 1, wherein the conversion comprises: generating the bitstream from the visual data, and
the method further comprises: storing the bitstream in a non-transitory computer-readable recording medium.

16. An apparatus for visual data processing comprising a processor and a non-transitory memory with instructions thereon, wherein the instructions upon execution by the processor, cause the processor to perform operations comprising:
performing a first conversion between visual data and a bitstream of the visual data with a neural network (NN)-based model, the first conversion comprising at least one of the following:
converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or
converting, based on a second predetermined order, a one-dimensional second array to a second tensor having more than one dimension, the second tensor and the second array storing second data associated with the visual data, and the second predetermined order indicating a correspondence between samples of the second tensor and samples of the second array.

17. The apparatus of claim 16, wherein the first array is an input to an entropy coder in the NN-based model, and the second array is an output of the entropy coder, or
wherein the first data or the second data comprises one of the following: probability parameter indices for coding the visual data, samples of a residual latent representation of the visual data, samples of a hyper tensor for coding the visual data, or samples of a skip mask for coding the visual data, or
wherein at least one of the first tensor or the second tensor has three dimensions, or
wherein at least one of the first predetermined order or the second predetermined order is a raster scan order.

18. The apparatus of claim 17, wherein in the raster scan order, all samples of a first channel are scanned before a sample of a second channel, and all samples of a first row within the first channel are scanned before a sample of a second row within the first channel.

19. A non-transitory computer-readable storage medium storing instructions that cause a processor to perform operations comprising:
performing a first conversion between visual data and a bitstream of the visual data with a neural network (NN)-based model, the first conversion comprising at least one of the following:
converting, based on a first predetermined order, a first tensor having more than one dimension to a one-dimensional first array, the first tensor and the first array storing first data associated with the visual data, and the first predetermined order indicating a correspondence between samples of the first tensor and samples of the first array, or
converting, based on a second predetermined order, a one-dimensional second array to a second tensor having more than one dimension, the second tensor and the second array storing second data associated with the visual data, and the second predetermined order indicating a correspondence between samples of the second tensor and samples of the second array.

20. The non-transitory computer-readable storage medium of claim 19, wherein the first array is an input to an entropy coder in the NN-based model, and the second array is an output of the entropy coder, or
wherein the first data or the second data comprises one of the following: probability parameter indices for coding the visual data, samples of a residual latent representation of the visual data, samples of a hyper tensor for coding the visual data, or samples of a skip mask for coding the visual data, or
wherein at least one of the first tensor or the second tensor has three dimensions, or
wherein at least one of the first predetermined order or the second predetermined order is a raster scan order.
